(19) United States
(12) Patent Application Publication
(10) Pub. No.: US 2008/0171453 A1
(43) Pub. Date: Jul. 17, 2008

(54) Conductive element and an electric connector using the same

(76) Inventor: Chien-Chih Ho, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,456

(22) Filed: Mar. 19, 2008

Related U.S. Application Data
(63) Continuation-in-part of application No. 11/318,880, filed on Dec. 28, 2005.

(51) Int. Cl. H01R 12/00; H01B 1/02

(52) U.S. Cl. 439/66; 174/9 F

(57) ABSTRACT

A conductive element and an electric connector using the same, wherein the conductive element is formed by plating a thin metal layer on the surface of a liquid electric conductor. The electric connector comprises an insulating body and at least a conductive element contained therein, wherein the conductive elements are formed by plating the thin metal layer on the surface of the liquid electric conductor. The conductive element of the present invention has a liquid metal with low impedance to obviously reduce the impedance of the conductive element, and it plates the thin meal layer on the surface of the liquid electric conductor to increase the elasticity of the conductive element. Besides, the structure of the conductive element is simple to manufacture easily.

This application is a Continuation-in-Part of application Ser. No. 11/318,880, filed 28 Dec. 2005, and entitled A CONDUCTIVE ELEMENT AND AN ELECTRIC CONNECTOR USING THE SAME.

### BACKGROUND OF THE INVENTION

1. Field of the invention

The present invention relates to a conductive element and an electric connector using the same.

2. Description of the Prior Art

The conductive elements as the conductive terminals which are made by punching the sheetmetals have widely been used in the industry. The sheetmetals have high impedance in the touching location, especially while the conductive terminals connecting to the butt electronic elements. Besides, in order to obtain better elasticity of the conductive terminals and then to bend the conductive terminals, not only increasing the length of the conductive terminals but increasing the impedance of the conductive terminals and then to impair the performance of the electrical connector. However, under the long-term usage it causes the bent conductive terminals to be permanent deformed so as to be in abnormal condition. Also, it makes the structure of the conductive terminals more complicated.

Thus, the inventor of the present invention recognizes the above shortage should be corrected and special effort has been paid to research this field. The inventor intend to resolve the above problems with the invention of reasonable design and good effect.

### SUMMARY OF THE INVENTION

It is an objective of the present invention to provide a conductive element with low impedance, simple structure, and better elasticity, and an electric connector using the same.

For achieving the objective stated above, the conductive element is formed depends on plating the thin metal layer on the surface of the liquid electric conductor.

The electrical connector of the present invention, comprising an insulating body and at least a conductive element contained in the insulating body, wherein the conductive element is formed depends on plating the thin metal layer on the surface of the liquid electric conductor.

Comparing to the prior art, the conductive element of the present invention has a liquid metal with low impedance to obviously reduce the impedance of the conductive element, and plating the thin metal layer on the surface of the liquid electric conductor to increase the elasticity of the conductive element. Besides, the structure of the conductive element is to be manufactured simply and easily.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a front view of a conductive element of the present invention;

FIG. 2 is a cross-sectional view of the conductive element illustrated in FIG. 1;

FIG. 3 is an assembled view of the conductive element and metals illustrated in FIG. 1;

FIG. 4 is a schematic view of a first method for forming a liquid electric conductor coated with a thin metal layer;

FIG. 5a is a cross-sectional view of colloids according to a second method for forming a liquid electric conductor coated with a thin metal layer;

FIG. 5b is a cross-sectional view of the colloids in FIG. 5a respectively coated with a thin metal layer on the surface thereof;

FIG. 5c is a cross-sectional view of the colloids in FIG. 5b received in receiving cavities;

FIG. 5d is a cross-sectional view of the thin metal layers received in the receiving cavities without the colloids illustrated in FIG. 5c;

FIG. 5e is a cross-sectional view of the liquid electric conductors received in the receiving cavities illustrated in FIG. 5d;

FIG. 5f is a cross-sectional view of the liquid electric conductors coated with the thin metal layer illustrated in FIG. 5e;

FIG. 6 is an assembled view of the insulating bodies and the conductive elements of the electric connector to the present invention;

FIG. 7 is a partial enlarged view of the FIG. 6;

FIG. 8 is an assembled view of the insulating body and the fixed frame illustrated in FIG. 6;

FIG. 9 is a top, assembled view of the insulating body and the fixed frame illustrated in FIG. 8; and

FIG. 10 is an assembled view of the insulating body, fixed frame, pressing mechanism and the adsorbing cover illustrated in FIG. 8.

### DETAILED DESCRIPTION OF THE PREFERRED EMBODIMENTS

Advantages and features of the invention will be apparent from the following description, drawings and claims.

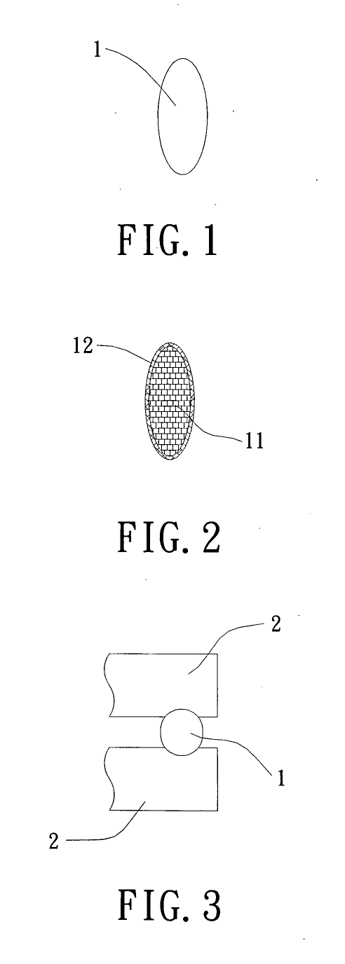

Reference is made from FIG. 1 to FIG. 3. A conductive element 1 comprises a liquid electric conductor 11 and a thin metal layer 12 plated thereon, and the conductive element 1 has been placed between two metals 2 to make the capability of electricity conduction.

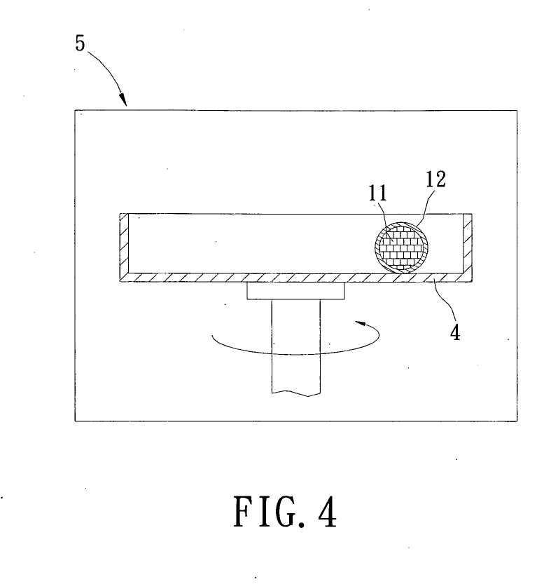

There are two methods for forming the liquid electric conductor 11 coated with a thin metal layer 12. Reference is made from FIG. 4. The first method is to drop the liquid electric conductor 11 into a rotary disk 4 which is set in a sputtering facility 5. The rotary disk 4 makes the liquid electric conductor 11 roll. While the liquid electric conductor 11 rolls on the rotary disk 4, the thin metal layer 12 is plated on the surface of the liquid electric conductor 11 by sputtering.

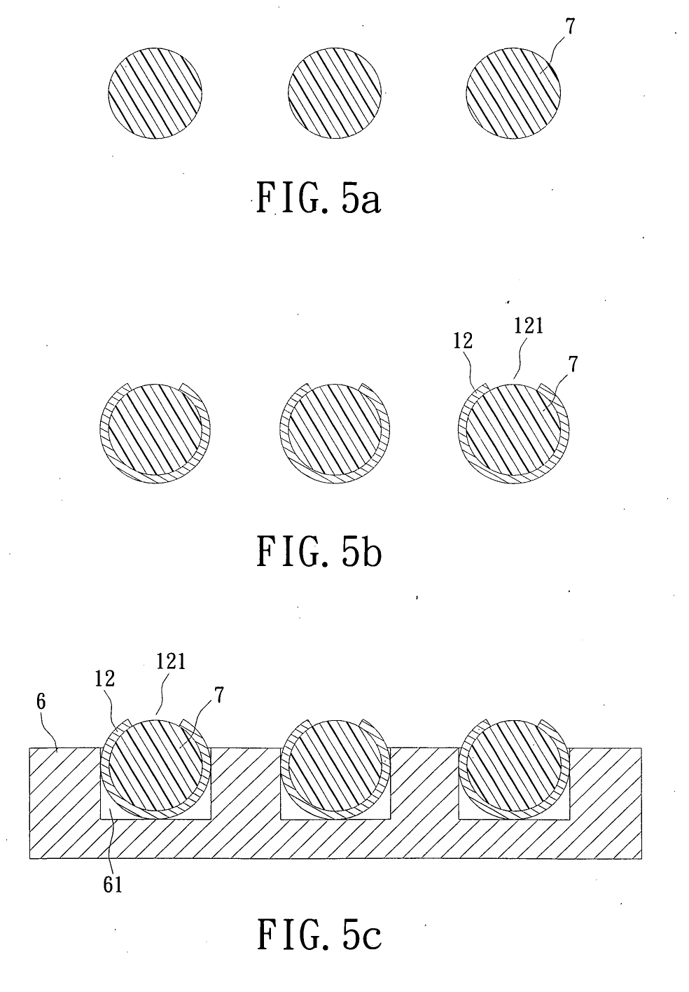

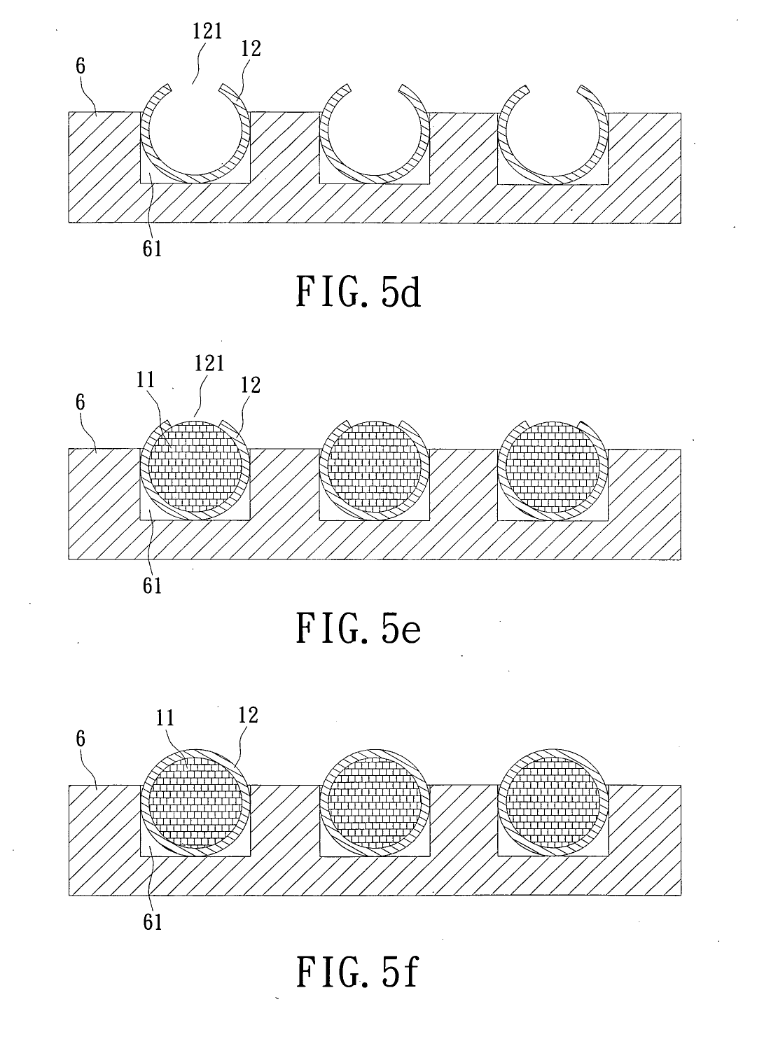

Reference is made from FIG. 5a to FIG. 5f. The other method is to offer a colloid 7 which is solid as it cools. Then the thin metal layer 12 is placed on the colloid 7 and has an aperture 121 near the surface of the colloid 7. Using a housing 6 comprising a plurality of receiving cavities 61 and the colloids 7 are put into the receiving cavities 61 respectively Then the colloid 7 is melted and drained through the aperture 121 of the thin metal layer 12. After that, the liquid electric conductor 11 is filled through the aperture 121 of the thin metal layer 12. Finally, the liquid electric conductor 11 is enclosed by the thin metal layer 12 by sealing the aperture 121 of the thin metal layer 12.

The conductive element 1 can stretch because its inner part can behave as an elastic sheet due to the surface tension of the liquid electric conductor 11 based on the property thereof. The liquid is mercury and the metal is gold in this present invention. The liquid electric conductor 11 has high cohesion, which makes the conductive element 1 elastic.

When the thin metal layer 12 is plated on the liquid electric conductor 11, an amalgam is formed between the liquid electric conductor 11 and the thin metal layer 12 due to a chemical reaction. The liquid electric conductor 11 coated with the thin metal layer 12 can deform due to the ductility and elongation of the thin metal layer 12.

The thin metal layer 12 is elastic and able to accommodate the cohesion force of the liquid electric conductor 11. Thus the liquid electric conductor 11 coated with the thin metal layer 12 can be kept and held in a fixed shape. The liquid electric conductor 11 deforms when an external force acts on the thin metal layer 12. If the thin metal layer 12 is strong enough, the thin metal layer 12 is prevented from cracking.

The conductive element 1 comprises a liquid metal with low impedance (liquid electric conductor 11) to obviously reduce the impedance of the conductive element 1, and plates the thin metal layer 12 on the surface of the liquid metal to increase the elasticity of the conductive element. Besides, the structure of the conductive is simple to manufacture easily.

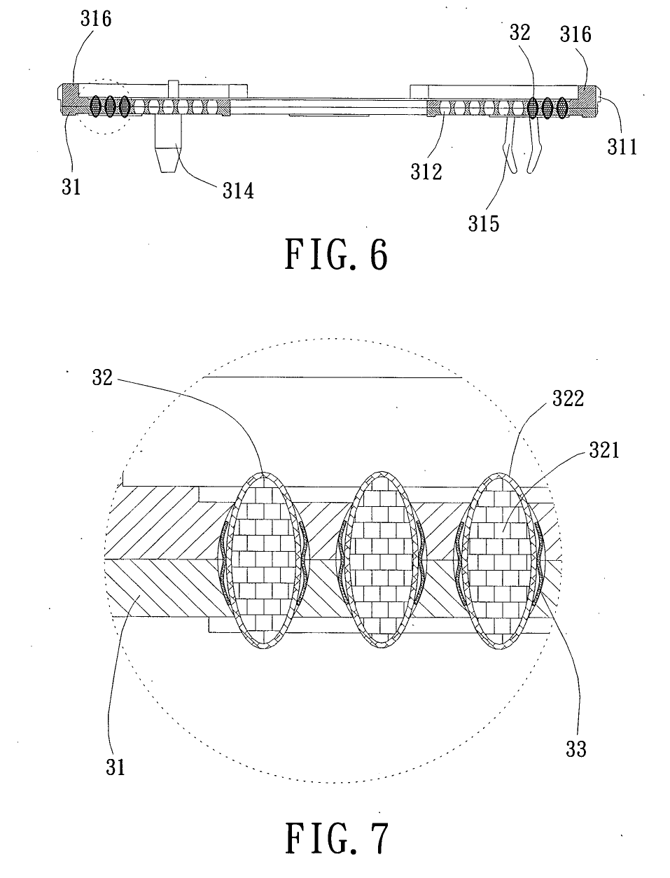

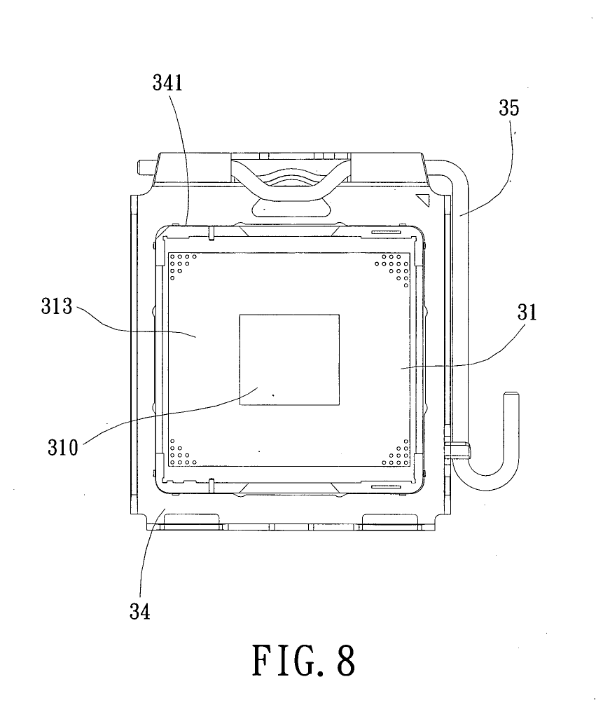

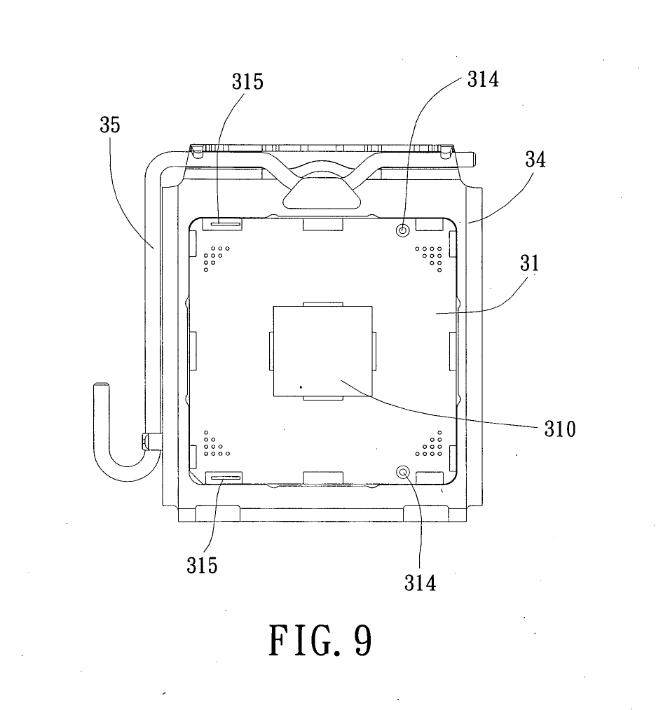

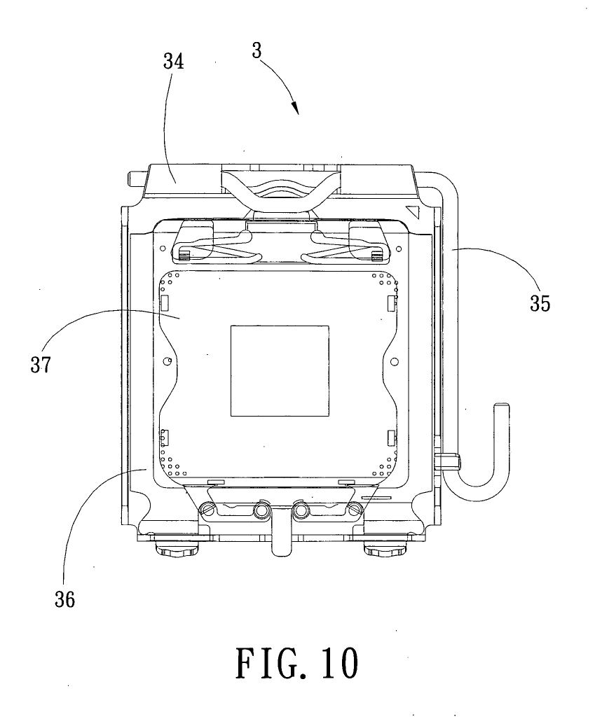

Reference is made to FIGS. 6 to 10. An electrical connector 3, comprising an insulating body 31 and at least a conductive element 32 contained therein, is used to connect a circuit board (not shown) and a chip module (not shown). The insulating body 31 has one upper surface and one lower surface, and a square opening 310 placed in the center region of the insulating body 31; the four sides of the insulating body 31 have a plurality of protruded lumps 311. A plurality of containing holes 312 have been placed between the two surfaces, and the containing holes 312 passed through the two surfaces for containing the conductive elements 32. An annular elastic body 33 further has been contained in the containing holes 312 (the elastic body 33 may be a metal piece) to elastically compress the conductive elements 312 to make them have more flexible; a conductive area 313 placed within the insulating body 31 has containing holes 312. Besides, a locating mechanism placed in the insulating body 31, comprising two locating pillars 314 and two hooks 315 separately placed in two outsides of the conductive area 313 of the insulating body 31. The locating pillars 314 downward extended from the bottom surface of the insulating body 31; one end of the hooks 315 is disposed on the insulating body 31 and the other end protrude from the bottom surface of the insulating body 31. The electrical connector 3 disposed on the circuit board via the locating pillars 314 and the hooks 315 (not shown). The locating mechanism further comprises locating frames 316, disposed on the edges of the upper surface of the insulating body 31, for locating the butt chip module (butt electronic elements) (not shown) on the electrical connector 3.

The conductive elements 32 contained in the containing holes 312 of the insulating body 31, and the conductive elements 32 are protruding to the outside of the upper surface and lower surface of the insulating body 31.

The conductive elements 32 comprises a thin metal layer 322 and a liquid electric conductor 321. The thin metal layer 322 is malleable and ductile, and therefore the liquid electric conductor 321 can deform. While the conductive elements 32 contains in the containing holes 312 of the insulating body 31, the containing holes 312 will press against the thin metal layer 322 and makes the thin metal layer 322 extend. The deformation of the thin metal layer 322 causes the deformation of the liquid electric conductor 321. Thus the conductive elements 32 can protrude to the outside of the upper surface and lower surface of the insulating body 31.

The electrical connector 3 still further comprises a fixed frame 34 to fix the insulating body 31 thereon, and therefore the protruded lumps 311 of the insulating body 31 mutually lock with inner edges 341 of the fixed frame 34. Furthermore, a rocker 35 is disposed on the fixed frame 34 and a pressing mechanism 36 with a pressing butt chip moduleis disposed on the insulating body 31. The pressing mechanism 36 pivotly connected to one side of the fixed frame 34 to make them mutually connected, and the pressing mechanism 36 and the fixed frame 34 are pressed together while the rocker 35 is closed. An adsorbing cover 37 disposed on the pressing mechanism 36 for a nozzle (not shown) adsorbing thereon during the automatic installation process. The adsorbing cover 37 is made of a transparent or partial transparent material to make the square openings 310 of the insulating body 31 quickly aim at the corresponding position while the electrical connector 3 welding with the circuit board (not shown) so as to improve working efficiency.

While the electrical connector 3 connecting to the circuit board (not shown), the chip module (not shown) connects to the electrical connector 3. Hence, the chip module (not shown) directly disposed on the conductive area 313 of the insulating body 31, and the conductive elements 32 extended from the upper surface of the insulating body 31 can be connected to spacers (not shown) of the chip module. And, pressing the pressing mechanism 36 on the chip module and then closing the rocker 35 to firmly press the pressing mechanism 36 on the conductive area 313 of the insulating body 31. The conductive element 32 comprises the thin metal layer 322 and the liquid electric conductor 321, and can withstand the compressive force from an external device. The electrical connection between the chip module and the circuit board is achieved.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A conductive element, which is formed by plating a thin metal layer on the surface of a liquid electric conductor.

2. An electrical connector, comprising an insulating body and at least a conductive element contained therein, wherein the conductive elements are formed by plating a thin metal layer on the surface of a liquid electric conductor.

3. The electrical connector as in claim 2, wherein the liquid electric conductor may be liquid mercury and the metal layer can be gold layer.

4. The electrical connector as in claim 2, wherein the insulating body at least has a containing hole and the conductive elements contained therein, and the insulating body having two surfaces and the containing hole of the insulating body passing through the two surfaces, and the conductive elements protruding to the two surfaces of the insulating body.

5. The electrical connector as in claim 4, wherein the containing hole comprising a elastic compressing body to elastically compress the conductive elements to make the conductive more flexible.

6. The electrical connector as in claim 5, wherein the elastic compressing body is an annular elastic body.

7. The electrical connector as in claim 5, wherein the elastic compressing body is a metal piece.

8. The electrical connector as in claim 2, wherein the insulating body at least has a protruded locating mechanism to position the electrical connector and butt electronic elements.

9. The electrical connector as in claim 8, wherein the top of the insulating body has a pressing mechanism to press the butt electronic elements.

10. The electrical connector as in claim 9, wherein the pressing mechanism has an adsorbing cover for a nozzle adsorbing on the pressing mechanism.
